(19) United States
(12) Patent Application Publication
(10) Pub. No.: US 2021/0034449 A1
(43) Pub. Date: Feb. 4, 2021

(54) INTEGRATED MODEL FOR FAILURE DIAGNOSIS AND PROGNOSIS

(71) Applicant: Patrick W. Kalgren, Conesus, NY (US)

(72) Inventor: Patrick W. Kalgren, Conesus, NY (US)

(21) Appl. No.: 16/998,985

(22) Filed: Aug. 20, 2020

Related U.S. Application Data
(63) Continuation of application No. 15/573,265, filed on Nov. 10, 2017, now abandoned.
(60) Provisional application No. 62/161,028, filed on May 13, 2015.

(51) Int. Cl. G06F 11/07; G06N 7/00; G06F 30/20

(52) U.S. Cl. CPC G06F 11/079; G06N 7/005; G06F 2111/20; G06F 11/0709; G06F 30/20

(57) ABSTRACT

A method for prognostic modeling includes obtaining probability values for possible health states of a system or component part using one or more data driven models and one or more physics failure models. A probabilistic network is built using a plurality of observed and latent variables. The probable outcomes from the one or more physics of failure models and the one or more data driven models are combined to create an integrated model for failure prognosis. A health state of the system or system component is predicted using the integrated model and the probabilistic network.

### CROSS REFERENCE TO RELATED APPLICATION

This application is a Continuation of U.S. patent application Ser. No. 15/573,265, filed Nov. 10, 2017, which claims priority to and benefit of U.S. Provisional Patent Application No. 62/161,028, filed May 13, 2015 and to PCT Application PCT/US2016/032126, filed May 12, 2016, all of which are incorporated by reference herein in their entirety.

### FIELD

Embodiments herein relate to diagnostics and prognostics, and more particularly failure prognosis for a system and its constituent parts.

### BACKGROUND

There are various examples of probabilistic graphical models being used for prognostics. One example is a data-driven approach, in which probabilistic graphical models can be learned automatically from data. However, data collection is often a challenge, especially for prognostics, and the data-driven models do not inherently use domain expertise or prior knowledge about the system modeled. Therefore, data driven prognostic modeling can require significant amounts of experience and data for mining to develop reliable models. Another approach to prognostics is to create physics-of-failure models, which use knowledge of failure mechanisms and physical properties to generate mathematical models of the system. However, development of physics-based, device-level prognostic models can require costly experimentation and field implementation may require extensive customization. Consequently, there are trade-offs and weaknesses to both approaches.

Conventional methods and systems have generally been considered satisfactory for their intended purpose. However, there is still a need in the art for systems and methods that provide for improved dynamic prognostic modeling. The present disclosure provides a solution for this need.

### SUMMARY

A method for prognostic modeling includes obtaining probability values for possible health states of a system or component part using one or more data driven models and one or more physics of failure models. A probabilistic network is built using a plurality of observed and latent variables. Probable outcomes from the one or more physics of failure models and the one or more data driven models are combined to create an integrated model for failure prognosis. A health state of the system or system component is predicted using the integrated model and the probabilistic network.

Predicting the health state can include predicting failure of the system or system component. Predicting the health state can include predicting degradation of electronics within the system or system component.

The probability values for possible health states can include likelihood values for each possible health state of the system or system component. Creating the integrated model can include incorporating the likelihood values as uncertain evidence in the one or more data-driven models. The likelihood values can include marginal likelihood values associated with different discrete states of the feature. Incorporating the likelihood values as uncertain evidence can include attaching a virtual evidence node to an observed node in each time slice of a given data-driven model.

The probability values for possible health states can further include cumulative probabilities of failure for each of a plurality of time slices. Creating the integrated model can further include using the cumulative probabilities as virtual evidence in the one or more data-driven models.

The probabilistic graphical model can include a dynamic Bayesian network and/or a continuous time Bayesian network. The probability values for possible health states can include a vector of time-indexed probability values.

A system for prognostic modeling includes a processor operatively coupled to a memory having instructions stored thereon that, when executed by the processor, causes the processor to obtain probability values for possible health states of a system or component part using one or more data driven models and one or more physics of failure models. A probabilistic network is built using a plurality of observed variables. The probable outcomes from the one or more physics of failure models and the one or more data driven models are combined to create an integrated model for failure prognosis. Failure of the system or system component is predicted using the integrated model and the probabilistic network. The processor may be further configured to transmit the predicted failure to one or more devices.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures.

FIG. 1 is a schematic view of an exemplary embodiment of a method for dynamic prognostic modeling in accordance with the present disclosure.

FIG. 2A is a schematic view of an exemplary network topology for a first-order dynamic Bayesian network (DBN) used in the method of FIG. 1.

FIG. 2B is a schematic view of an exemplary network topology for a continuous time Bayesian network (CTBN) used in the method of FIG. 1.

FIG. 3A is an illustrative example of a DBN for incorporating uncertain evidence through virtual evidence nodes used in the method of FIG. 1.

FIG. 3B is an illustrative example of virtual evidence used in the method of FIG. 1.

FIG. 4 shows an exemplary virtualization of interface between physics-of-failure results and data-driven model for diagnosis using the method of FIG. 1.

FIG. 5 shows an exemplary virtualization of interface between physics-of-failure results and data-driven model for prognostics using the method of FIG. 1.

FIG. 6 is a schematic view of an exemplary system for implementing an embodiment of the method shown in FIG. 1.

### DETAILED DESCRIPTION

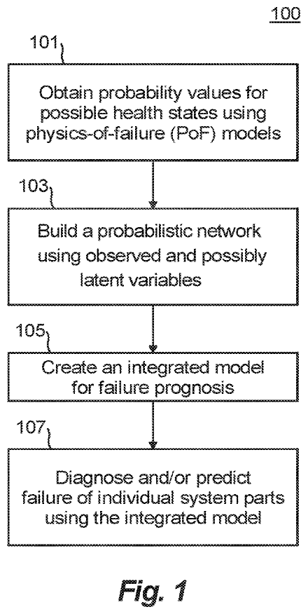

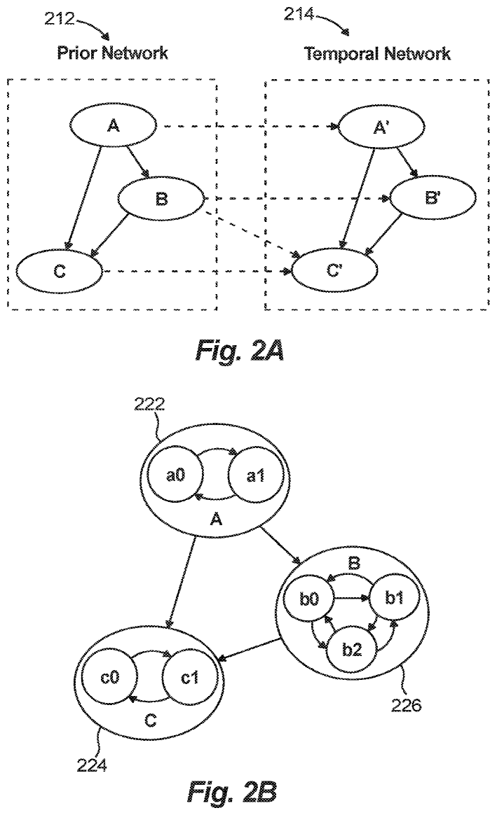

Reference will now be made to the drawings wherein like reference numerals identify similar structural features or aspects of the subject disclosure. For purposes of explanation and illustration, and not limitation, a partial view of an exemplary embodiment of a method and system for predicting health states of systems and/or system components in accordance with the disclosure is shown in FIG. 1 and is designated generally by reference character 100. Other embodiments of the system and method in accordance with the disclosure, or aspects thereof, are provided in FIGS. 2-6, as will be described. Systems and methods described herein can be used for dynamic diagnostic/prognostic modeling, for example, for predicting failure of individual parts of a system.

Effective application of “condition-based maintenance” (CBM) and“prognostic and health management” (PHM) of complex systems requires a uniform, consistent, and disciplined approach to development, application, and utilization of prognostic models that leverage previously demonstrated capabilities for incipient fault detection and degraded health condition, prior to functional failure, of monitored devices and systems.

Analysis of signal behavior from sensing and control systems yields understanding to develop first principle models that explain underlying physical wear phenomena, permitting PHM engineers to develop physics-based diagnostic and predictive models useful for system maintenance, planning, and safe operation in degraded states. Physics-based prognostic modeling for these purposes can be defined as an approach combining failure mechanism understanding via damage accumulation models and simulation-based operational tracking techniques to perform system prognostic modeling. Such modeling and correlation of system dynamics, signals, and material condition typically requires extensive dedicated laboratory controlled testing and development.

Physics agnostic, data driven approaches can yield similar explanatory results, incorporating usage data and information latching in a probabilistic model along with state estimation techniques to perform prognostics. However, data collection is often a challenge, especially for prognostics, and the data-driven models do not inherently use domain expertise or prior knowledge about the system modeled. Therefore, data driven prognostic modeling can require significant amounts of experience and data for mining to develop reliable models.

Generally, system-level behavioral models, physical process models, and data-driven artificial intelligence-based (AI) models have similar attributes which permit abstraction that enables consistency in the representation of these models for information processing and automated test systems. This consistency permits and enables a disciplined, affordable, and testable, approach to integration and utilization of CBM and PHM into existing maintenance systems. The combination of physics-based and data driven techniques has been shown to increase the overall accuracy of either approach alone. This result is significant, in that, not only can a change in health state be detected, prior to functional failure, but that change can also be explained and duplicated using models. These models, in turn, enable the prediction of potential future behavior based on the change observed in the current behavior.

Embodiments herein utilize Dynamic Bayesian Networks (DBN) to integrate physics-of-failure (PoF) models with data-driven (DD) models. PoF models can use measurements from a system to compute probability values for possible health states. DD models, such as probabilistic graphical models, can be built using all observed variables, as well as latent (i.e., unobserved) variables, and include nodes to interface with PoF model results. The outcome is a fused model incorporating physics-based modeling and data-driven modeling capable of utilizing all available system knowledge and data.

Those skilled in the art will readily appreciate that the system and method described herein are suitable for various other applications wherein diagnostic/prognostic modeling is useful.

With reference to FIG. 1, embodiments herein provide a method 100 for integrating the results of physics-of-failure (PoF) models with data-driven (DD) models. At step 101, the PoF models are given observed measurements of a system on which to perform prognostics, and the models compute/obtain probability values for the different health states of the feature to predict. Observed measurements can come from sensors, test equipment, etc. For example, probability values produced by the PoF models may include marginal likelihoods up through the current time for diagnostics and cumulative probabilities into the future for prognostics. At step 103, the probabilistic graphical models/probabilistic network are built using all observed variables and any latent variables, but they also include nodes that interface with the PoF model results. At step 105, an integrated model is built by combining the probable outcomes from the PoF models and the DD models, the integration can be done by setting uncertain evidence in these nodes that match the probabilities returned by the PoF models. Embodiments herein can interface the PoF results with both dynamic Bayesian networks (DBNs) and continuous time Bayesian networks (CTBNs). At step 107, the integrated model can be used to diagnose the health state or predict failure of the system or system components.

The PoF models are designed to predict a specific feature about the system modeled. For example, the PoF models could be attempting to describe the likely evolution of a power supply as it nears its end-of-life. The feature to be predicted is represented by a discrete set of semantic labels such as {Healthy, Degraded, Faded}. The PoF models are given a set of observed time-series measurements from the system modeled. The PoF model returns a vector of time-indexed probability values. These probabilities could be likelihood values, representing the probability of the system being in each of the states; or the vector could hold a cumulative probability distribution, representing the probabilities of whether the system has failed or not up to the given time.

Method 100 includes integrating PoF models with DD models y using the probability estimates returned by the PoF models as uncertain evidence in the probabilistic graphical models. Embodiments herein use two such probabilistic graphical models, the DBN and the CTBN, both of which are further delineated below.

FIGS. 2A and 2B show example network topologies for a first order DBN and a CTBN, respectively, modeling the same three-node system. Bayesian networks are probabilistic graphical models that use nodes and arcs in a directed acyclic graph to represent a joint probability distribution over a set of variables. Formally, suppose that P(X) is a joint probability distribution over n variables x₁, . . . , xₙ ϵ X, and that Parents(xᵢ) denotes the parents of the node xᵢ, in the network. Then the graphical structure of the network factors the joint probability distribution as,

$$P ( X ) = {\prod }_{i = 1}^{n} P ( {x}_{i} \vert Parents ( {x}_{i} ) ) .$$

The DBN expands on the Bayesian network by using a series of one-way-connected time slices, each of which contain a copy of a regular Bayesian network Xₜ,indexed by time t. The probability distribution of variable at a given time slice can be conditionally dependent on states of that variable (or even other variables) throughout any number of previous time slices. The simplest type of DBN models are first-order DBNs, which means that the nodes of each time slice are conditionally independent of all nodes further back given the immediately previous time slice. This can be represented mathematically as,

$$P ( {X}_{0} … {X}_{k} ) = P ( {X}_{0} ) {\prod }_{t = 0}^{k} P ( {X}_{t = 1} \vert {X}_{t} ) .$$

Spanning multiple time slices, the DBN can include any evidence gathered throughout that time and use it to help reason about state probability distributions across different time slices. Often, the conditional probability tables of the DBN can be defined compactly by defining a prior network X₀ and a single temporal network Xₜ. The temporal network Xₜ, is then “unrolled” into X₁, X₂, . . . Xₖ. for k time slices. FIG. 2A shows an example DBN using the prior network 212 and temporal network 214.

The DBN model has been used in many application areas that have sequences of observations. Often these problems are concerned with performing classification only in the current time slice or timestep based on prior evidence. However, DBNs can also be unrolled further into the future and forecast future states based on the evolving marginal probabilities. For example, predictive tasks that the DBN can be used for include clinical prognostics and mechanical prognostics. Unrolling a DBN further allows a greater prediction horizon, but the effect of evidence in the current time slice on future time slices deteriorates at a geometric rate.

The CTBN uses a set of conditional Markov processes and is structured like a Bayesian network, in which the topology of the network encodes conditional independence/dependence relationships among the nodes. However, instead of discrete or continuous random variables, each node is a Markov process. Furthermore, child nodes are conditional Markov processes, a type of non-homogeneous Markov process whose transition intensities vary, not as a function of time, but based on the current states of the node's parents in the network.

Formally, let X be a set of Markov processes {X₁, X₂, . . . , Xₙ}, where each process Xᵢ, has a finite number of states. A CTBN N over X consists of two components. The first is an initial distribution denoted Pₓ⁰ over X, which can be specified as a Bayesian network B. This distribution Pₓ⁰ only used for determining the initial state of the process, calculated by forward sampling, for example. The second is a continuous-time transition model, which describes the evolution of the process from its initial distribution, specified as:
a directed graph G with nodes X₁, X₂, . . . , Xₙ, where Pa(Xᵢ) denotes the parents of Xᵢ in G.
a set of conditional intensity matrices A_{X|Pa(X)} associated with X for each possible state instantiating of Pa(X).

FIG. 2B shows an example CTBN with the states of the Markov processes inside each of nodes 222, 224 and 226 of the CTBN. CTBNs have found applications in various dynamic domains. For example, CTBNs may be used to reason about users' presence and activities in computer applications, model social network dynamics, assess both network and host level intrusion detection systems, diagnose cardiogenic heart failure and for systems reliability modeling.

Integration of the probabilities returned by the PoF model into the data-driven models through the use of uncertain evidence is described below. Systems implementing method 100 may include two types of interfaces. The first uses marginal likelihoods associated with the different discrete states of the feature to predict. The second uses cumulative probabilities associated with a two-state node for whether the system has entered the failed state or not. The next two sections describe these two types of interfaces and their uses.

In the first type of interface, the PoF model returns likelihood values each state of the feature to predict. One way to incorporate this as evidence into the models is to find the state with the highest likelihood and set this state as evidence. However, this ignores the amount of uncertainty that the physics-of-failure model provides along with its prediction. Instead, the models can use these likelihood values as uncertain evidence.

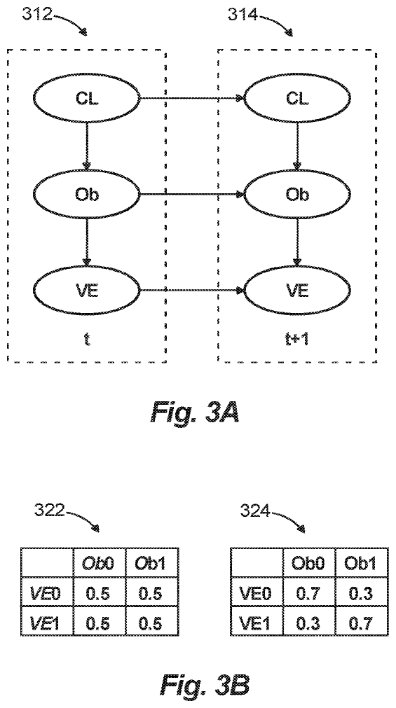

For DBNs, to simulate uncertain evidence, an additional node is added as a child to the PoF prediction node in each time slice as virtual evidence nodes. FIG. 3A shows an example of a DBN for incorporating uncertain evidence through the use of virtual evidence nodes, such that the added virtual evidence nodes are attached to the observed nodes at time t, shown as time slice 312, and time t−1, shown as time slice 314, for incorporating uncertain evidence. The node CL represents the class label, i.e., the state to be predicted. The node Ob represents an observed node. The node VE is the virtual evidence node that is used to incorporate the uncertain evidence for Ob.

When an Ob node is unobserved, the conditional probability table (CPT) of the child VE node is populated with a uniform probability, e.g., 1/2 for a two-state PoF prediction node. The uniform probabilities ensure that these nodes do not influence the marginal probabilities of the other nodes. To set uncertain evidence for an Ob node, the CPT for the corresponding VE node is replaced by a CPT with probabilities that incorporate the uncertain evidence.

FIG. 3B shows an example of virtual evidence, with table 322 representing initial conditional probabilities of virtual evidence nodes and table 324 representing the probabilities in table 322 which are then changed to incorporate virtual evidence. Suppose that the network has an observed node Ob with two states as shown in the table 324. A virtual evidence node VE is added as a child to this node, having two states that correspond to the uncertain evidence of being in each of the parent states. Suppose that the uncertain evidence states that there is 0.7 probability of being in Ob0 and 0.3 probability of being in Ob1. The CPT is updated and node VE is set as observed in state VE0, Corresponding to the 0.7 probability Ob0 and the 0.3 probability of Ob1.

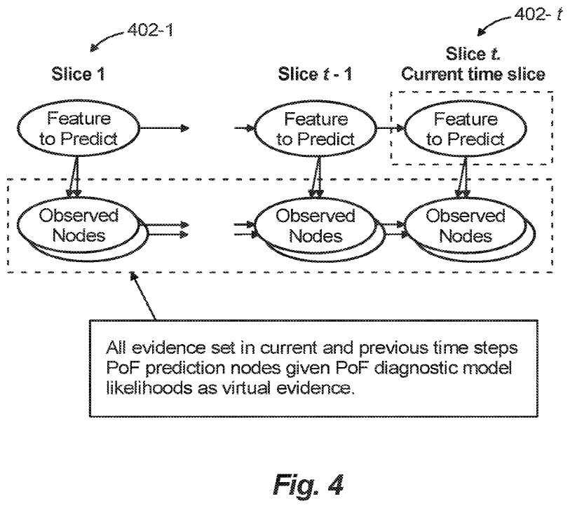

At each time slice, the models are given the observed states for that point in time as well as all previous time slices. The state likelihood values returned by the PoF model for the current and previous time slices are set as virtual evidence in the corresponding and previous PoF prediction nodes in the DD model. The DBN can then be queried to find the most probable state of the feature to predict at each time slice. FIG. 4 illustrates this type of interface for integrating the PoF results into a diagnostic DBN model, the interface having time slices 402-1 . . . 402-t.

For including uncertain evidence into the CTBN, the inference algorithms themselves may be changed to accommodate the uncertainty in the evidence. For approximate inference using sampling techniques, for example, the transitions in the sample paths for the PoF states can be chosen based on the uncertainty in the PoF results.

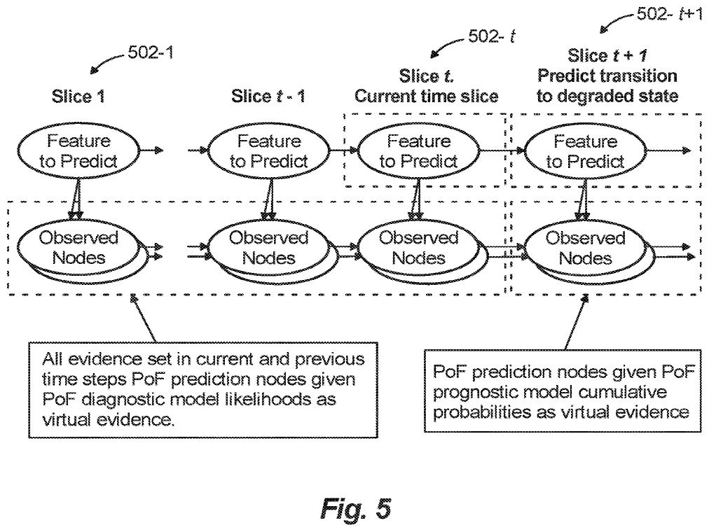

For the type of interface involving prognostics through cumulative probabilities, the PoF model includes a cumulative probability of failure at each time slice. In this prognostic use case, the PoF results from the interface described above (i.e., using likelihood values as uncertain evidence in DD models) are used as virtual evidence up through the current time slice. Then the cumulative probabilities are used as virtual evidence past the current tune slice to the end of the unrolled DBN. FIG. 5 illustrates both types of interfaces for integrating the PoF results into a prognostic DBN model having time slices 502-1. . . . 502-t+1. For the CTBN, modifications to the inference algorithms will also be able to handle the two-state nodes for integrating the cumulative probabilities.

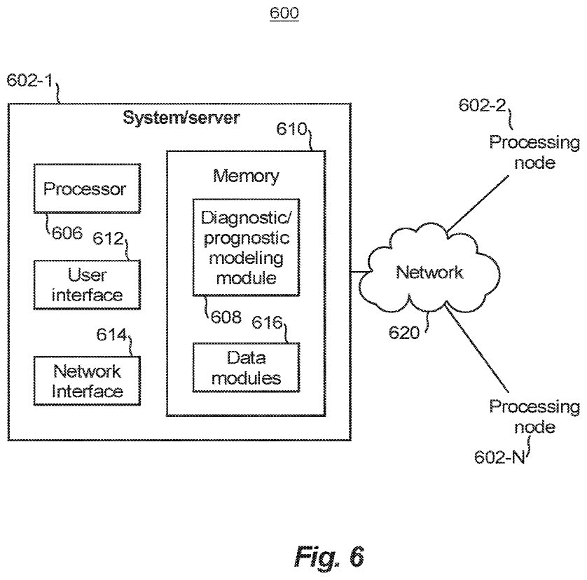

Results from the integrated model may be provided to a user via one or more computing devices and/or transmitted to one or more devices via a network (e.g., network 620 of FIG. 6). Embodiments herein may be used for predicting failure in electronic systems or electronic system components, for example, for predicting degradation of electronics within the system and/or system components of an aircraft.

For example, a system implementing an embodiment described herein be used to predict and/or detect degradation of an electronic power supply. Variables for the PoF model may include output voltage, input current, power loss, leakage current and PoF prediction. The PoF model can return likelihood values for each state of the leakage current.

The DBN can use these likelihood values as uncertain evidence. As noted earlier, the node CL represents the class label, i.e., the state to be predicted. The node Ob represents an observed node. The node VE is the virtual evidence node that is used to incorporate the uncertain evidence for Ob. When an Ob node is unobserved, conditional probability table (CPT) of the child VE node is populated with a uniform probability, e.g., 1/6 for each of the six states of the PoF prediction node. The uniform probabilities ensure that these nodes do not influence the marginal probabilities of the other nodes. To set soft evidence for an Ob node, the CPT for the corresponding VE node is replaced by a CPT with probabilities that incorporate the soft evidence (e.g as shown in the tables similar to those of FIG. 3B, having additional Ob and VE nodes). For diagnosis, the combined DD and PoF model, the state likelihood values returned by the PoF model for the current and previous time steps are set as uncertain evidence in the corresponding current and previous PoF prediction nodes in the DD model. Each time step may correspond to a month, a week, a day or any other suitable period of time. (e.g., t in FIG. 4 may be a month, a week or a day; feature to predict FIG. 4 may be leakage current).

For prognosis, the PoF model returns a cumulative probability of failure at each step. For example, failure for the PoF model may be defined by a threshold value on the derivative of the power loss. This threshold may be chosen as the average of the derivative values at time of failure over the instances in a training set. For the DD and combined models, the leakage current states are replaced by a single binary state, according to a specified threshold value of the leakage current, which maximizes model performance based on the above threshold. Thus, the prognostic models are predicting the time step (e.g., in FIG. 5, t may be a month) at which the power supply becomes degraded.

For the combined prognostic model, the PoF diagnostic predictions are used as uncertain evidence up through the current time step. The cumulative probabilities are used as uncertain evidence past the current time step to the end of the unrolled DBN. The length of the DBN can be set longer than the longest lifespan of any power supply instance, and the probabilities converged to a failure prediction in all cases. The combined model described above provides greater accuracy of detecting the level of degradation for the electronic power supply compared to conventional models.

Embodiments herein provide improved performance by combining the PoF model results into the DBN model. The integrated model improves on the diagnostic accuracy on more-degraded states, which have fewer instances in both the training and testing set but are more critical for detecting the level of degradation. The integrated model also provides better prognostic accuracy than the stand-alone DBN model.

Advantageously, embodiments herein can provide reduced development costs and increased capability. Physics-based model development can focus on critical areas and reuse more general models. Integrated models support broader initial system coverage and greater capability growth on fielded systems. Utilizing failure data demonstrably provides improved performance on both diagnostic and prognostic outcomes over each approach individually.

FIG. 6 depicts an illustrative system 600 for implementing methodology 100 of FIG. 1. System 600 includes processing nodes 602-1 . . . 602-N, configured to communicate over a network 620. Each of processing nodes 602-1 . . . 602-N may be configured as shown in computer system/server 602-1, which may include, but is not limited to, personal computer systems, server computer systems, hand-held or laptop devices, multiprocessor systems, microprocessor-based systems, programmable consumer electronics, network PCs, and the like. Computer system/server 602-1 may include one or more processors 606 coupled to a memory 610, a user interface 612 and a network interface 614. Memory 610 may include instructions stored thereon, that when executed by processor 606, causes the processor 606 to perform one or more steps of method 100. Memory 610 may comprise a diagnostic/prognostic modeling module 608 for implementing one or more steps of methodology 100 of FIG. 1. Memory 610 may also include data module(s) 616 maintained for each critical part or module of parts in a system (e.g., a power supply). Each data module 616 can include data relevant to at least one of material, manufacture, assembly, green run, and service for the respective parts. User interface 612 may be configured to enable user input into the computer system/server 602-1.

The computer system 602-1 may optionally include network interface 614, which may be configured to enable the computer system 602-1 to interface with a network 620 and other system components. Network 620 may be a communication link comprising an internet connection, Ethernet link, local area link, cellular link, satellite link, global system for mobile communication (GSM), etc. It is to be appreciated that system 600 may include more or less components than shown in FIG. 6. Each of the processing nodes 602-1 . . . 602-N may also include more or less components than shown and described herein.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “device,” “module” or “system.” Furthermore, aspects of the present invention may take the form of a computer program product embodied in one or more computer readable medium having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 1 is intended to provide a brief, general description of an illustrative and/or suitable exemplary method according to which embodiments of the above described present invention may be implemented. FIG. 1 is exemplary of a suitable method and is not intended to suggest any limitation as to the structure, scope of use, or functionality of an embodiment of the present invention. A particular method should not be interpreted as having any dependency or requirement relating to any one or combination of components illustrated in an exemplary operating method. For example, in certain instances, one or more elements of the method may be deemed not necessary and omitted. In other instances, one or more other elements may be deemed necessary and added.

The methods and systems of the present disclosure, as described above and shown in the drawings, provide for dynamic diagnostic/prognostic modeling. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method for prognostic modeling, comprising:
obtaining probability values for possible health states of a system or component part using one or more data-driven models and one or more physics of failure models;
building a probabilistic network using a plurality of observed and latent variables;
combining probable outcomes from the one or more physics of failure models and the one or more data-driven models to create an integrated model for failure prognosis; and
predicting a health state of the system or system component using the integrated model and the probabilistic network;
wherein the obtaining, building and creating are performed by at least one processor coupled to a memory.

2. The method of claim 1, wherein predicting the health state includes predicting failure of the system or system component.

3. The method of claim 1 or claim 2, wherein predicting the health state includes predicting degradation of electronics within the system or system component.

4. The method of any one of claims 1-3, wherein the probability for possible health states include likelihood values for each possible health state of the system or system component.

5. The method of claim 4, wherein creating the integrated model includes incorporating the likelihood values as uncertain evidence in the one or more data-driven models.

6. The method of claim 4 or claim 5, wherein the likelihood values include marginal likelihood values associated with different discrete states of the feature.

7. The method of any one of claims 4-6, wherein incorporating the likelihood values as uncertain evidence includes attaching a virtual evidence node to an observed node in each time slice of a given data-driven model.

8. The method of any one of claims 4-7, wherein probability values for possible health states further include cumulative probabilities of failure for each of a plurality of time slices.

9. The method of claim 8, wherein creating the integrated model further includes using the cumulative probabilities as virtual evidence in the one or more data-driven models.

10. The method of any one of claims 1-9, wherein the probabilistic network includes a dynamic Bayesian network.

11. The method of any one of claims 1-10, wherein the probabilistic network includes a continuous time Bayesian network.

12. The method of any one of claims 1-11, wherein the probability values for possible health states include a vector time-indexed probability values.

13. A system for prognostic modeling, comprising:
a processor operatively coupled to a memory having instructions stored thereon that, when executed by the processor, causes the processor to:
obtain probability values for possible health states of a system or component part using one or more data driven models and one or more physics of failure models;
build a probabilistic network using a plurality of observed and latent variables;
combine probable outcomes from the one or more physics of failure models and the one or more data driven models to create an integrated model for failure prognosis; and
predict health state of the system or system component using the integrated model and the probabilistic network.

14. The system of claim 13, wherein the processor is further configured to predict failure of the system or system component.

15. The system of claim 13 or claim 14, wherein the processor is further configured to transmit the predicted health state to one or more devices.
